(19) United States
(12) Patent Application Publication
(10) Pub. No.: US 2013/0270366 A1
(43) Pub. Date: Oct. 17, 2013

(54) Height-Adjustable Sprinkler

(71) Applicant: Louis H. Junker, Erie, CO (US)

(72) Inventor: Louis H. Junker, Erie, CO (US)

(21) Appl. No.: 13/446,804

(22) Filed: Apr. 13, 2012

(51) Int. Cl. A62C 31/02

(52) U.S. Cl. 239/397

(57) ABSTRACT

A spray assembly configured has an extensible pole may be adjusted to different heights that accommodate plants during a season of growth.

### FIELD

The present disclosure pertains to the field of sprinkler systems, and particularly sprinklers that may be used for gardening applications in the watering of plants.

### STATEMENT OF THE PROBLEM

Water irrigation systems are used in gardening applications to distribute water, and sometimes also soluble nutrients, to plants in need thereof. The systems may be constructed from a wide variety of familiar hoses, sprinklers, sprayers, misters and valves that are available on commercial order.

Due to a need to conserve scarce water resources, the art is trending towards distributed delivery systems that provide water precisely at the point where it is needed. Thus, the areal extent of a garden may be provided with tubing and drip valves or sprinklers that distribute water to each particular plant in a garden, but withhold water from portions of the garden that do not contain plants. Alternatively, valves may be provided for selective adjustment of water flow to plants in the garden that have less need of water.

Many home and professional gardeners perceive a benefit to spraying water onto the foliage for their plants. While the art provides generally for the areal or horizontal distribution of water, plants also exist in various heights that may change significantly as the plants grow. It is problematic that, other than manual spraying from handheld apparatus, the art does not provide for variation of water distribution according to the height of the plant.

### SOLUTION

The presently disclosed instrumentalities overcome the problems outlined above and advance the art by providing a variable height spray assembly that may be selectively adjusted for variation of water distribution according to the height of the plant

In one aspect, a spray assembly for delivering water to a spray nozzle through tubing is improved by having a spray nozzle mounted upon a selective height adjustment mechanism. The height adjustment mechanism includes an upper tubular member and one or more lower tubular member(s). The upper tubular member and the lower tubular member(s) telescopically received within the other, or vice-versa.

Means is provided for locking upper tubular member and the lower tubular member into a temporarily fixed position with respect to one another. This adjusts an overall height of the spray assembly.

In one aspect, the locking mechanism or ‘means’ may include a collet assembly that is actuated for engagement into a fixed locking position by opposing rotational movement of the upper tubular member relative to the lower tubular member. The collet assembly is disengaged by opposite rotational movements into an unfixed mode permitting sliding telescopic movement to adjust the overall height of the spray assembly.

In one aspect, the locking mechanism or ‘means’ may include a bayonet latch mechanism to assist with the placement and anchoring of the spray assembly.

### BRIEF DESCRIPTION OF THE DRAWINGS

FIG. 1 shows a spray assembly that may be adjusted to various heights for the distribution of water to plants that grow to different levels during a single growing season;

FIG. 2 is an assembly view of the spray assembly shown in FIG. 1;

FIG. 3 is a midsectional view of the spray assembly shown in FIG. 1 that provides additional details of a rotational locking mechanism;

FIG. 4 is shows a bayonet latch mechanism that may be used to adjust handle position of handle to assist placement and anchoring of spray assembly; and

FIG. 5 shows the detail of the adapter which receives the spray nozzle

### DETAILED DESCRIPTION

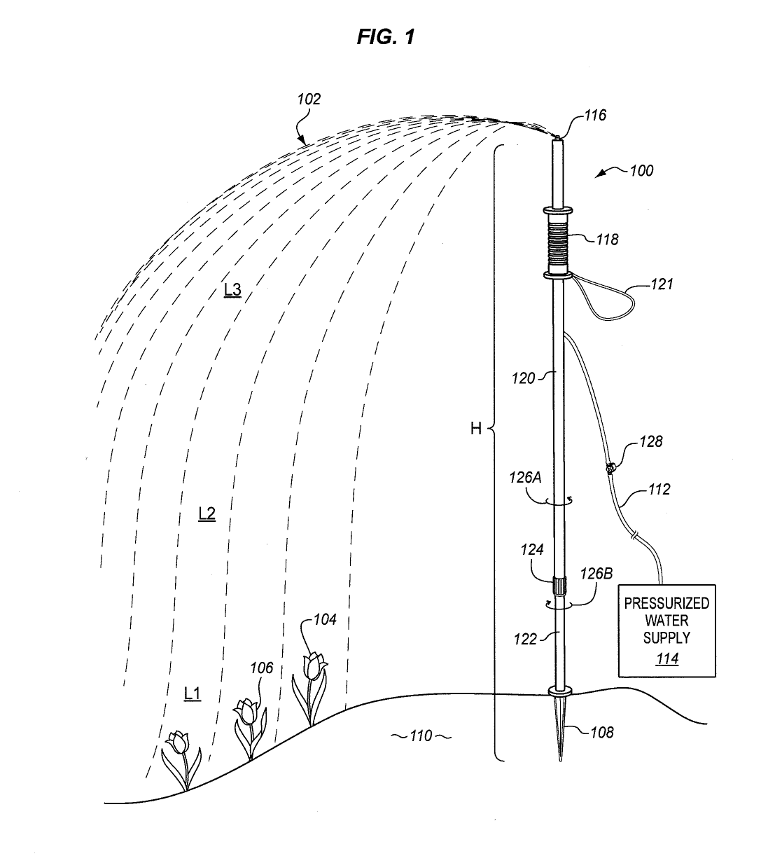

FIG. 1 shows a spray assembly 100 dispensing a spray of water 102 to plants 104, 106. A stake tip 108 retains the spray assembly 100 in earth 110. Flexible tubing 112, such as ¼ inch vinyl tubing, communicates water from a supply 114 to spray nozzle 116 which dispenses the spray of water 102. A grip handle 118 surrounds an elongate upper tubular member 120 at a radially outboard location and may be used to impart additional gripping force for sinking the stake tip 108 into and out of the earth 110. A lower tubular member 122 is telescopically received within the upper tubular member 120. A plastic bushing 124 resides at the lower distal end of upper tubular member 120 to prevent water damage to the internal mechanism and mitigate possible scratching of the lower tubular member 122 as it slides into and out of the upper tubular member 120. An internal locking mechanism (not shown) is provided atop the portion of lower tubular member 122 that resides within the upper tubular member 120 and so is hidden from view in FIG. 1. A valve 128 may be adjusted to regulate the flow of water through tubing 112.

The spray assembly 100 is selectively locked and unlocked at a height H by selective manual actuation of opposed turning motions 126a, a126b about the elongate axis of assembly 100. The upper and lower tubular members may be rotated in one direction as shown in FIG. 1 to engage the locking mechanism, and in the opposite direction to disengage the locking mechanism such that the lower tubular member 122 is released for sliding telescopic movement within the upper tubular member 120. It will be appreciated that plants 104, 106, as shown in FIG. 1, reside at level L₁; however, throughout the course of an entire growing season these same plants may grow to a height at level L₂ and then level L₃. As shown in FIG. 1, the height H of spray assembly 100 is appropriate for L₃, but not L₁, and so the assembly 100 may be reduced to a new overall height dimension that is more appropriate to level L₁. Later in the growing season the spray assembly 100 may be lengthened to accommodate levels L₂ and then L₃.

It will be appreciated that the pressurized water supply 114 may be a hose or tubing coupled with a well or a city water supply. A plurality of spray assemblies 100 with the same or different spray patterns and spray ranges may be connected in series to a single water supply line in the mariner of what is conventionally known as a drip system.

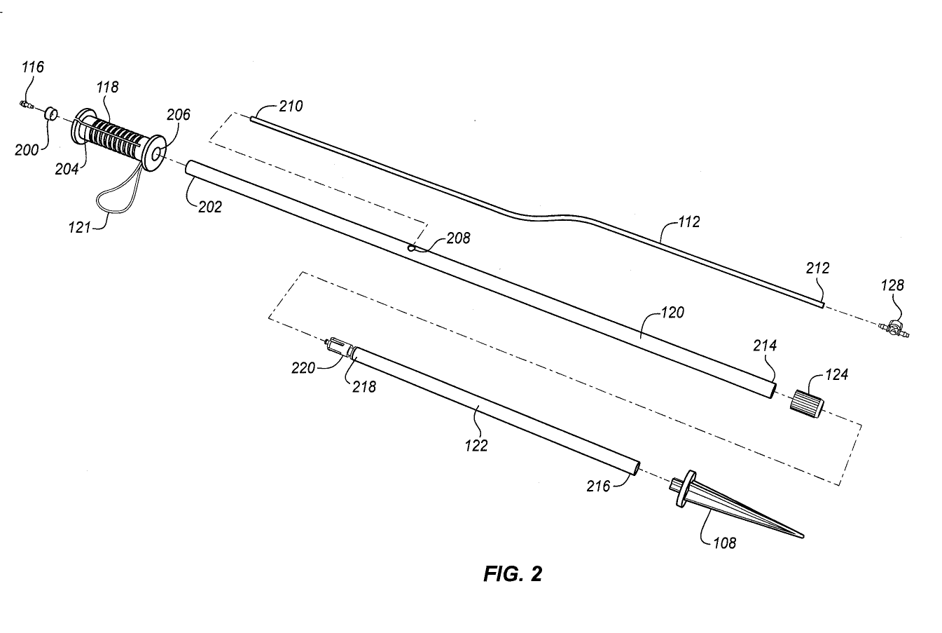

FIG. 2 presents an assembly view of the spray assembly 100 using identical part numbers for parts already described above. A specialized adapter 200 is within the upper end 202 of upper tubular member 120 to hold the spray nozzle 116. The specialized adapter is constructed in a manner which allows for its removal when flexible tubing 112 requires replacement due to wear and tear (see FIG. 5). It will be appreciated that the spray nozzle 116, valve 128, and tubing 112 may be purchased on commercial order, for example, from RainDrip, Inc. of Fresno, Calif. The spray nozzle 116 may be designed for the spraying or misting of water, and so the spray assembly has alternative uses, such as in outdoor cooling applications where mist is prayed to cool people or animals on a hot summer day.

The grip handle 118 may be press-fit or adhered to the upper tubular member 120 at any fixed position. The grip handle 118 is optionally provided with a bayonet latch mechanism permitting selective sliding adjustment of the grip handle at any position on upper tubular member 120, as described below. A flexible strap 121 is provided for storage of the spray assembly during the non-growing season.

The tubing 112 passes through aperture 208 such that end 210 is fastened to the adapter 200 which retains the spray nozzle 116. Valve 128 may be press-fit or adhered to end 212. The plastic bushing 124 may be press fit or adhered to end 214 of the upper tubular member 120. The stake tip 108 may be press fit or adhered to end 216 of the lower tubular member 122.

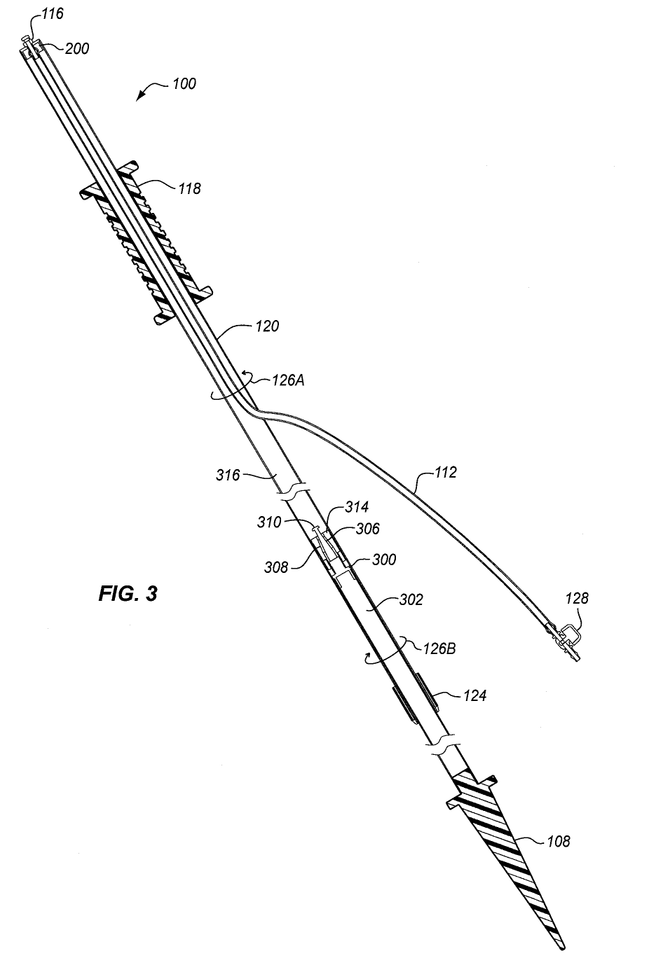

Upper end 218 of the lower tubular member 122 contains the aforementioned internal locking mechanism, now designated mechanism 220 in FIG. 2. FIG. 3 presents a more detailed view of mechanism 220 where a clamp 300 is rigidly affixed to an interior surface 302 of the lower tubular member 122, and retains a central conical wedge 306 that tapers upwardly along wall 308 towards a distal shoulder 310. The lower section 312 of wedge 306 is threadably received within clamp 300 such that rotation of clamp 300 relative to threaded lower member 122 causes movement of the wedge 300 relative to clamp 300 and an elastomeric collet 314. This motion may cause tightening of collet 314 against shoulder 310 drives the collet 314 into compression and, consequently also, radial outboard expansion against the inner surface 316 of upper tubular member 120. Reverse rotational movement reduces this radial expansion such that the tubular members 120, 122 may be telescopically aligned for selective height adjustment of height H, as described above. Preferably, the collet 300 is always in some compression against the inner surface 316 because this provides friction facilitating the locking and unlocking rotations 126a, 126b.

It will be appreciated that it is not necessary for the lower tubular member 122 to fit within the upper tubular member 120. If the situation is reversed, such that the upper tubular member 120 telescopes into the lower tubular member 122, then the locking mechanism 220 may reside at the bottom of upper tubular member 120, instead of residing atop the lower tubular member 122.

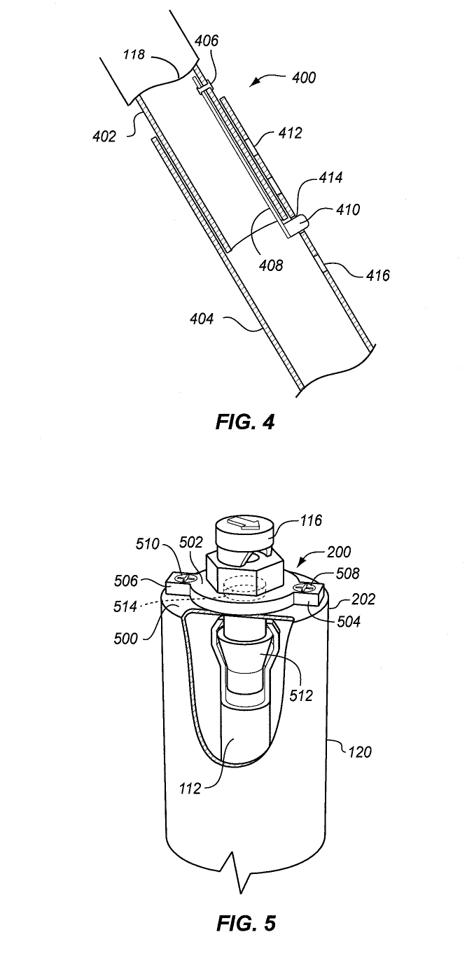

FIG. 4 shows an optional locking mechanism 400 generally in the form of a bayonet latch that may be provided to adjust the position of handle 118. The handle 118 is mounted on an inner tubular member 402 is telescopically received within an outer tubular member 404. A rivet 406 attaches a spring 408 to the inner tubular member 402. Spring 408 drives a head 410 into engagement with any selected one of a plurality of apertures 412, 414, 416 to lock the inner and outer tubular members 402, 404 at a selected position. This may be undone by manually depressing the head 410 against the bias of spring 408 until the head 410 is removed from the selected aperture. In this case, rotational movement is not required for selective height adjustment.

FIG. 5 provides additional detail regarding the manner of mounting the adapter 200 upon end 202 of the upper tubular member 120. End 202 has a cap or wall 500. The adapter 200 is optionally formed as a circular plate 502 with wings 504, 506 extending in a radially outboard direction. Screws 508, 510 attach wings 504, 506 to the wall 500. As shown in FIG. 5, a portion of end 202 is removed to show tubing 112 connected to a barbed end 512 of spray nozzle 116. The spray nozzle 116 is optionally press-fit or threadably received in a central opening 514 of the adapter 200.

The foregoing discussion teaches by way of illustration and example, not by limitation of the disclosed embodiments. As such, the disclosure should not be interpreted in a manner that is unduly limiting. It will also be appreciated by those of ordinary skilled in the art that insubstantial changes may deviate from what is disclosed, without departing from the true scope of the invention. Accordingly, the inventor states his intention to rely upon the doctrine of Equivalents in protecting the full scope of what is described and claimed.

What is claimed is:

1. In a spray assembly for delivering water to a spray nozzle through tubing, the improvement comprising:
the spray nozzle mounted upon a selective height adjustment mechanism including an upper tubular member and a lower tubular member,
one of the upper tubular member and the lower tubular member being telescopically received within the other, and
means for locking upper tubular member and the lower tubular member into a temporarily fixed position with respect to one another to adjust an overall height of the spray assembly.

2. The spray assembly of claim 1, wherein the means for locking includes a collet assembly that is actuated for engagement into a fixed locking position by opposing rotational movement of the upper tubular member relative to the lower tubular member, and disengaged by opposite rotational movements into an unfixed mode permitting sliding telescopic movement to adjust the overall height of the spray assembly.

3. The spray assembly of claim 1, wherein the means for locking includes a bayonet latch mechanism for adjustment of the handle position to assist the placement and anchoring of the spray assembly.

4. The spray assembly of claim 1, wherein the spray nozzle is a mist nozzle.

5. The spray assembly of claim 1 including a plurality of the spray assemblies with different spray patterns and ranges connected in series to a single water supply line.

6. The spray assembly of claim 1, including grip piece mounted on the upper tubular member, the grip piece being made of a flexible material with a bayonet latch mechanism permitting selective adjustment of the position of the grip piece on the upper tubular member.

7. A method of gardening that comprises:
adjusting the spray assembly of claim 1 to a variety of selected heights during a single growing season, and
distributing water to plants in a garden at each of the selected heights.

8. A method of distributing water by spray assembly of claim 1 which reduces evaporative water loss by using a height adjusted distributed water delivery system.
